(19) United States
(12) Patent Application Publication
(10) Pub. No.: US 2014/0379378 A1
(43) Pub. Date: Dec. 25, 2014

(54) System and Method for Generating a Medical Summary Report

(71) Applicant: KONINKLIJKE PHILIPS N.V., EINDHOVEN (NL)

(72) Inventors: ERIC COHEN-SOLAL, OSSINING, NY (US); MICHAEL CHUN-CHIEH LEE, LEXINGTON, MA (US); Thusitha Dananjaya De Silva MABOTUWANA, YONKERS, NY (US)

(21) Appl. No.: 14/308,811

(22) Filed: Jun. 19, 2014

Related U.S. Application Data
(60) Provisional application No. 61/837,216, filed on Jun. 20, 2013.

(51) Int. Cl. G06F 19/00

(52) U.S. Cl. CPC G06F 19/3487; G06F 19/322
USPC 705/3

(57) ABSTRACT

A system and method for generating summary data based on a patient report. The method includes receiving at least one patient report of a plurality of patient reports. The patient report includes first data relating to a patient. The method also includes analyzing the at least one patient report to identify at least one section as a function of predetermined identifiers. The method also includes analyzing the at least one section to identify second data relating to the patient. The method also includes generating summary data as a function of the identified second data.

Physicians often document outcomes of exam interpretation or patient visits in a form of text reports. One example of such reports is a radiology report. The report produced by a radiologist or clinician typically summarizes important aspects of a patient history and clinical context, and then indicates his/her findings and associated anatomical regions visually present in radiological image(s), if any.

The findings in the report are presented in a findings section and then are interpreted in a conclusion (or impression) section of the report. The conclusion section is a section that is separate from the findings section. The purpose of the conclusion section is to answer the clinical question (described in the imaging order). It should not be a repetition of the findings and should, instead, be an interpretation of the finding(s) in the clinical context. In practice, the conclusion section contains different pieces of information, a sub-set of which may be relevant to future patient examination.

One of the first tasks which the radiologist/clinician performs in protocoling or reading/reporting of the images is to get a sense of the clinical context of the patient. Depending on the patient, a number of prior reports (resulting from previous examinations of the patient) ranges from a few to many. As described above, the report usually includes free text with a number of sections. Depending on the style of the radiologist/clinician, the text in the report can be in the form of a long prose, or a set of smaller paragraphs within a section, or presented in a succession of short sentences or bullet points.

Reading prior reports takes time and does not usually present a compact view of the patient's prior information. Most of the time, the radiologist reviews the most recent report focusing first on the conclusion section and then, if needed, on the finding section to look for specific findings.

Over the years, a number of studies per radiologist and an average complexity of studies have dramatically increased, thereby increasing the load on radiologists. Because the radiologist needs to quickly move from one case to another, there are time constraints for efficiently reviewing patient information. This can result in less time spent by the radiologist reviewing prior reports.

The present invention relates to a method for generating summary data. The method includes receiving at least one patient report of a plurality of patient reports. The patient report includes first data relating to a patient. The method also includes analyzing the at least one patient report to identify at least one section as a function of predetermined identifiers. The method also includes analyzing the at least one section to identify second data relating to the patient. The method also includes generating summary data as a function of the identified second data.

In another embodiment, the present invention relates to a system configured to generate summary data. The system includes a memory arrangement storing a retrieval module and a natural language processing (NLP) module. The retrieval module is configured to retrieve a plurality of patient reports, each patient report including first data relating to a patient. The system also includes a processor configured to, via the NLP module, (i) receive at least one patient report from the plurality of patient reports, (ii) analyze the at least one patient report to identify at least one section as a function of predetermined identifiers, (iii) analyze the at least one section to identify second data relating to the patient, and (iv) generate summary data as a function of the identified second data. The system also includes an input/output device configured to receive input data from and present output data to a user.

In a further embodiment, the present invention relates to

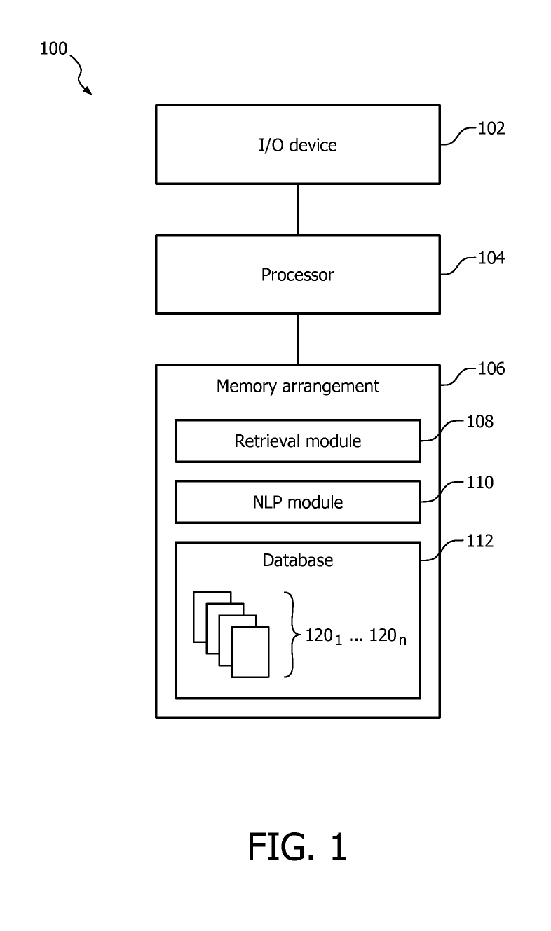

FIG. 1 shows a schematic drawing of a system according to an exemplary embodiment of the present invention.

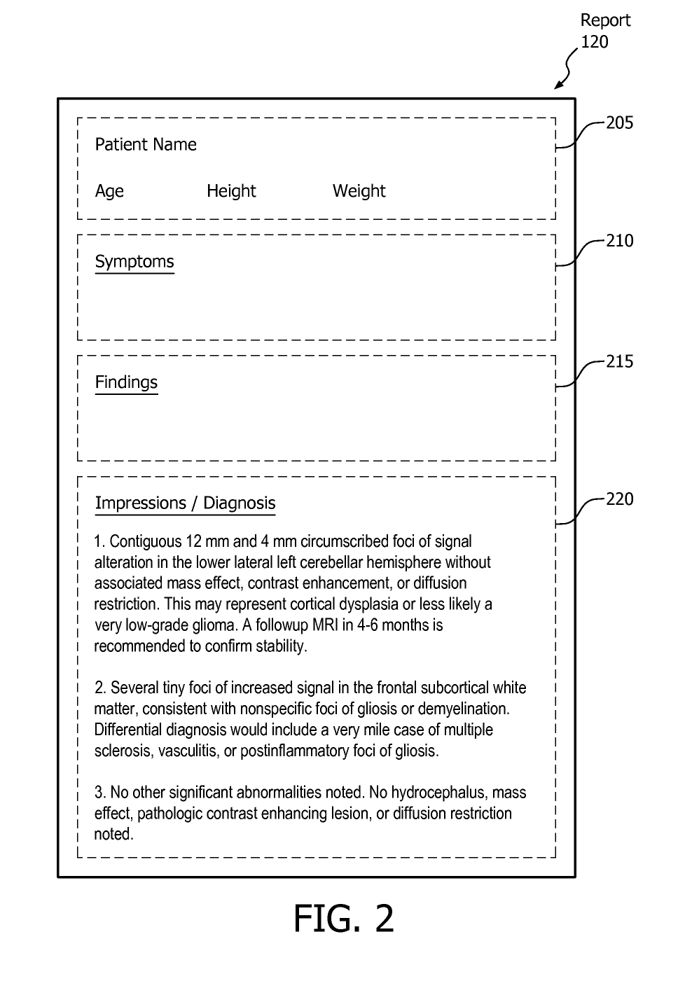

FIG. 2 shows a report according to an exemplary embodiment of the present invention.

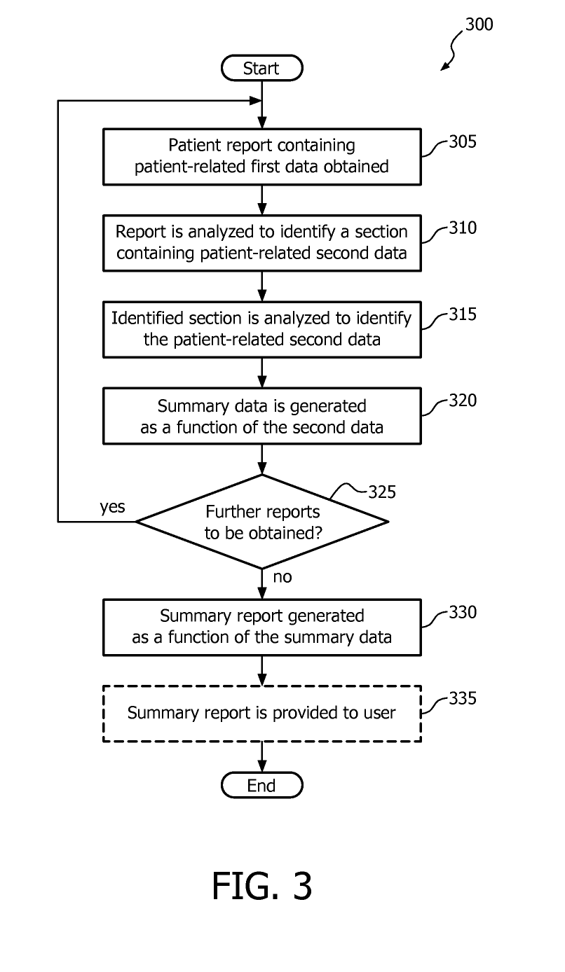

FIG. 3. shows a method according to an exemplary embodiment of the present invention.

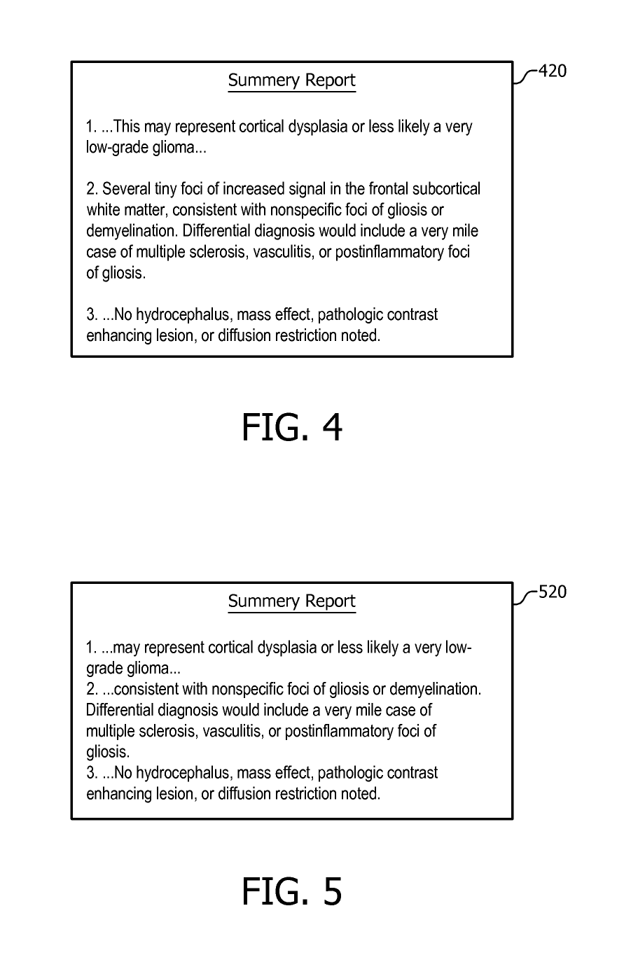

FIG. 4 shows a summary report according to an exemplary embodiment of the present invention.

FIG. 5 shows a summary report according to a further exemplary embodiment of the present invention.

The exemplary embodiments may be further understood with reference to the following description and the appended drawings, wherein like elements are referred to with the same reference numerals. The exemplary embodiments relate to a method and system for generating a summary report of patient data. Although the exemplary embodiments are specifically described in regard to a radiology department, it will be understood by those of skill in the art that the system and method of the present invention may be used for patients having any of a variety of diseases or conditions within any of a variety of hospital departments.

FIG. 1 shows a system 100 according to an exemplary embodiment of the present invention. The system 100 generates a summary report based on a plurality of patient reports 120₁ . . . 120ₙ that may include medical findings and diagnoses pertaining to a patient. It should be understood that the reports 120₁ . . . 120ₙ may include one or more reports associated with any medical field such as, for example, radiology, neurology, urology, etc.

The system 100 includes an input/output (I/O) device 102, a processor 104, and a memory arrangement 106. The system 100 may be any computing device such as, for example, a computer, a tablet, a handheld device, etc. The I/O device 102 receives input data from a user via, for example, a mouse, a keyboard, a touch screen, a microphone, an electronic transfer etc. and outputs data to the user via, for example, a display, a speaker, a printer, a predetermined file transfer etc.

The memory arrangement 106 stores a plurality of software which is executed by the processor 104. For example, the memory arrangement 106 may include a retrieval module 108 configured to retrieve all the 120₁ . . . 120ₙ reports associated with a current patient; a natural language processing (NLP) module 110 configured to analyze the retrieved report(s) and performing the exemplary method of the present invention; and a database 112 configured to store the reports 120₁ . . . 120ₙ. Elements of the system 100 may be connected using conventional wired connections (e.g., CAT5, USB, etc.), wireless connections (e.g., Bluetooth, 802.11 a/b/g/n, etc.), or any combination thereof.

FIG. 2 shows an exemplary embodiment of the report 120. Each report 120 may include, for example, a section 205 containing first data relating to the patient; a symptoms section 210; a findings section 215; and an impressions (or diagnosis) section 220. The first data may include various information relating to the patient, such as, for example, patient name, age, weight, height, demographic information, medical history, lifestyle information, etc. The findings section 215 may include, for example, descriptions based on visual observations of anatomical regions displayed in a medical image on which a patient diagnosis is based. The impressions section 220 may contain impressions/interpretations based on information in the findings section 215 of the report 120.

The NLP module 110, using the processor 104, generates the summary report as a function of all the reports 120₁ . . . 120ₙ associated with the patient. FIG. 4, which will be described in greater detail later, illustrates an exemplary summary report 420 which is generated based on the method shown in FIG. 3.

After the retrieval module 108 retrieves a first report 120₁ from the plurality of reports 120₁ . . . 120ₙ, the NLP module 110 analyzes the retrieved report 120₁ to perform the exemplary method of the present invention. Specifically, the NLP module 110 analyzes the retrieved report 120₁ to identify a section (e.g., the impressions section 220) in the report 120₁ as a function of predetermined identifiers. The identified section contains second data for further processing. It should be noted that any section in the report 120₁ may be used to extract information for inclusion in the generated summary report 420. For example, the NLP module 110 may analyze information in the findings section 215 as well as the impressions section 220. Examples of the second data that may be found in the impressions section 220 of the report 120₁ are illustrated in FIG. 2.

The NLP module 110 subsequently analyzes the identified section of the report 120₁ to identify the second data relating to the patient. The second data may include, for example, physician or radiologist impressions and conclusions based on the findings section (FIG. 2). Subsequently, the NLP module 110 generates summary data as a function of the identified second data. Finally, the NLP module 110 generates the summary report 420 based on the summary data. The generated summary report 420 is then displayed to the user on the I/O device 102.

FIG. 3 illustrates an exemplary method of the present invention for generating the summary report 420. In step 305, the retrieval module 108 obtains the first report 120₁ from the plurality of the reports 120₁ . . . 120ₙ from the database 112. In another exemplary embodiment, the reports 120₁ . . . 120ₙ may be received by the retrieval module 108 from a source outside of the system 100.

In step 310, the NLP module 110 analyzes the retrieved report 120₁ to identify, as a function of predetermined identifiers (described below), a portion/section that contains second data relating to the current patient (e.g., the impressions section 220). The second data will be described in greater detail below with regards to step 315. Although the present invention relates to the second data in the impressions section 220 of the report 120₁, one of ordinary skill in the art will understand that that the second data may be found in any section of the report 120₁.

In step 315, the NLP module 110 analyzes the section identified in step 310 to identify the second data. The second data may include, but is not limited to diagnoses, impressions based on the findings section, recommendations, etc. The step 315 may be performed using various techniques and predetermined algorithms, which may be based on various sentence boundary detection techniques.

In one exemplary embodiment, the technique involves the use of supportive phrases. A supportive phrase is defined as a set of consecutive words that are used in a sentence (or in its vicinity) to indicate the presence of important, key second data. It is possible to produce an exhaustive list of the supportive phrases since a number of ways in which the author of the report 120₁ generates the report 120₁ is somewhat limited. The supportive phrases include regular expressions or similar methods, allowing for wildcards (i.e., variable words endings). For example, the supportive phrases in the following sentences are each italicized, underlined, and boldfaced:
Calcifications are present in the liver, consistent with chronic granulomatous disease.
There is decreased attenuation throughout the liver compatible with diffuse fatty infiltration.
Significant advancement of left frontal tumor, now with extensive ring-type in heterogeneous enhancement.
Stable left parietal paramidline dural-based meningioma, unchanged since Jun. 1, 2004.

Based on the specific supportive phrase used in a sentence, the NLP module 110 can determine whether the second data is located before or after the supportive phrase. The second data precedes the supportive phrase in the last of the above-listed examples. In contrast, the second data is found after the supportive phrase in the first three of the above-listed examples. In order to detect the interpretation, the NLP module 110 uses a medical ontology to locate second data, for example, corresponding to a diagnosis or a disease. In addition, natural language processing (NLP) techniques may be used to identify parts of sentences corresponding to medical interpretations (e.g., speech tagging, stemming, string matching with medical concept synonyms).

In another embodiment, the NLP module 110 identifies the second data without the use of supportive phrases by identifying medical terminology. Usually, this technique is utilized when the author of the report 120₁ has used some type of shorthand form to indicate his/her conclusions (e.g., bullet points). For example, the medical terminology in the following sentences/phrases are each italicized, underlined, and boldfaced:
Mild left hilar lymphadenopathy
Mild diffuse atrophy and scattered small focal and confluent areas of chronic microvascular ischemic gliosis in the cerebral white matter and minimally involving the pons

In this embodiment the identification of the second data is performed by identifying sentences/phrases with important medical information such as, for example, a diagnosis and/or medical results. In addition, this embodiment may also include further filtering by ensuring that no verb is present in the sentence/phrase (thereby guaranteeing that the sentence/phrase is actually a sentence fragment).

In a further embodiment, the NLP module 110 may use a machine-learning technique to identify the second data in the report 120₁. This technique requires a training set of annotated sentences categorizing each sentence as either a key sentence or a non-essential sentence, which may be achieved using manually verified key and non-essential sentences. In this technique, the NLP module 110 may identify key sentences among the other sentences in the identified section. Segments of text that may be safely suppressed may also be identified. This technique also requires a list of features that describe a sentence in a way that would discriminate between the key sentences and the non-essential sentences. For example, such a list may contain features based on n-grams and more specific descriptors. First, a dictionary of n-grams for each n (typically, n=1, 2, or 3) from the training set of annotated sentences is extracted. Each dictionary is reduced to contain only n-grams that appear in the training set more than a predetermined number of times (e.g., more than 5 times in the training set). For normalization purposes, the features that describe the sentence have values between 0 and 1. Such features may include, but are not limited to, features in the following exemplary list:
Percentage of words (unigram, n=1) in sentence computed as ratio: # of words/threshold
Percentage of n-grams not found in n-gram dictionary, for each value of n
0 or 1 depending on sentence containing a number of words less than a predetermined threshold
0 or 1 depending on the presence of a supportive phrase in sentence
0 or 1 depending on the presence of a medical condition in sentence
0 or 1 depending on the presence or absence of at least one verb

In a further embodiment, the NLP module 110 may determine the “direction” of the supportive phrase, if any. The “direction” of the supportive phrase indicates on which side of the supportive phrase (i.e., before or after) the most relevant information is located. For example, the supportive phrase “suspicious for” may have a “forward direction.” That is, important second data associated with the patient is most likely located after this phrase.

In another further embodiment, a list of patterns of text (e.g., “an area of,” “due to,” “there is”) that can safely be removed may be stored on the memory arrangement 106. This list may be used to eliminate unimportant text so that the identified second data may be presented in a more concise manner.

One of ordinary skill in the art will understand that this is not a complete list of techniques and that any of the above or other techniques may be utilized to identify the second data in step 315. In all of the above-described embodiments, the NLP module 110 determines whether repeat information is present in more than one report 120₁ . . . 120ₙ. If the NLP module 110 determines that repeat information is present, then it will suppress all additional instances of that information.

In step 320, the NLP module 110 generates summary data as a function of the second data identified in step 315. The summary data may be generated using the above-explained techniques to eliminate terms that are not part of the identified second data.

In step 325, a determination is made if there are more reports 120₁ . . . 120ₙ associated with the current patient (e.g., stored on the database 112 or at a remote location). If there are more reports 120₁ . . . 120ₙ to be retrieved, the method 300 returns to step 305 and proceeds as described above for every remaining report 120₁ . . . 120ₙ associated with the current patient.

When, at step 325, it is determined that there are no more reports 120₁ . . . 120ₙ associated with the current patient, the method 300 proceeds to step 330.

In step 330, the NLP module 110 generates the summary report 420 as a function of the summary data generated in step 320. As illustrated in FIG. 4, the summary report 420 displays a truncated form of the second data (e.g., information included in the impressions section 220) identified in step 315. The I/O device 102 may allow the user to interact (e.g., perform a selection) with the second data of the summary report 420 to display the report 120 that corresponds to that data.

FIG. 5 illustrates a further exemplary embodiment of a summary report 520 according to the present invention. In this further embodiment, the NLP module 110 may, in step 320, further truncate the summary data of the summary report 420 using the techniques described above. This further truncation may generate further summary data, as displayed in the summary report 520. As illustrated, the summary report 520 may be limited to only the medical interpretations/diagnoses by suppressing any unnecessary text, using the techniques described above.

In another embodiment, the NLP module 110 may provide an indication when it determines that certain second data is present in more than one of the plurality of reports 120₁ . . . 120ₙ, as explained above. For example, the NLP module 110 may provide a numerical indication next to the repeated second data in the summary report 420.

In a further embodiment, the NLP module 110 may detect the presence of negative supportive phrases in the vicinity of second data in the reports 120₁ . . . 120ₙ. In this scenario, the NLP module 110 may reorder the second data in the summary report 420 so that the second data with the negative supportive phrases appears first. For example, the following exemplary sentences contain negative supportive that is italicized, underlines, and boldfaced.
Overall, no significant change in sequela of neurofibromatosis with continued hamartomas changes, small glioma of the left optic nerve, and astrocytoma near the left fornix when compared to the prior studies
No findings worrisome for malignancy

Finally, at step 335, the NLP module 110 presents the summary report 420 to the user via, for example, the I/O device 102. It should be noted, however, that the summary report 420 may be provided to the user in various known methods, such as, for example, on a display, printed, in an email, etc. It should further be noted that step 335 may be optional and the summary report 420 may be stored on the memory arrangement 106 instead of being provided to the user.

It is noted that the claims may include reference signs/numerals in accordance with PCT Rule 6.2(b). However, the present claims should not be considered to be limited to the exemplary embodiments corresponding to the reference signs/numerals.

Those skilled in the art will understand that the above-described exemplary embodiments may be implemented in any number of manners, including, as a separate software module, as a combination of hardware and software, etc. For example, the retrieval module 108 and the NLP module 110 may be programs containing lines of code that, when compiled, may be executed on by processor 104 to perform the exemplary method 300.

It will be apparent to those skilled in the art that various modifications may be made to the disclosed exemplary embodiments and methods and alternatives without departing from the spirit or scope of the disclosure. Thus, it is intended that the present invention cover the modifications and variations provided that they come within the scope of the appended claims and their equivalents.

1. A method (300), comprising:
receiving (305) at least one patient report (120) of a plurality of patient reports (120₁ . . . 120ₙ), the patient report (120) including first data relating to a patient;
analyzing (310) the at least one patient report (120) to identify at least one section as a function of predetermined identifiers;
analyzing (315) the at least one section to identify second data relating to the patient; and
generating (320) summary data as a function of the identified second data.

2. The method (300) of claim 1, further comprising:
generating (325) the summary data for each of the plurality of patient reports (120₁ . . . 120ₙ); and
generating (330) a summary report (420, 520) as a function of the summary data generated for the plurality of patient reports (120₁ . . . 120ₙ).

3. The method (300) of claim 2, further comprising:
providing (335) the summary report (420, 520) to a user.

4. The method (300) of claim 1, wherein the second data comprises medical results pertaining to the patient.

5. The method (300) of claim 1, wherein the second data is identified using natural language processing (NLP) sentence boundary detection algorithms.

6. The method (300) of claim 1, wherein the second data is identified by determining which sentences or phrases in the at least one section contains first medical information.

7. The method (300) of claim 6, wherein the first medical information is identified using predetermined supportive phrases which indicate the presence of at least one of a medical diagnosis or interpretation.

8. The method (300) of claim 6, wherein the first medical information is determined by identifying the presence of medical diagnosis or interpretation.

9. The method (300) of claim 2, wherein the generating (330) of the summary report (420, 520) step further includes a substep of suppressing specific instances of the second data that appear in more than one of the plurality of patient reports.

10. A system (100), comprising:
a memory arrangement (106) storing a retrieval module (108) and a natural language processing (NLP) module (110), the retrieval module (108) being configured to retrieve a plurality of patient reports (120₁ . . . 120ₙ), each patient report (120) including first data relating to a patient;
a processor (104) configured to, via the NLP module (110), (i) receive at least one patient report (120) from the plurality of patient reports (120₁ . . . 120ₙ), (ii) analyze the at least one patient report (120) to identify at least one section as a function of predetermined identifiers, (iii) analyze the at least one section to identify second data relating to the patient, and (iv) generate summary data as a function of the identified second data; and
an input/output device (102) configured to receive input data from and present output data to a user.

11. The system (100) of claim 10, wherein the processor (104) is further configured to (a) generate the summary data for each of the plurality of patient reports (120₁ . . . 120ₙ), and (b) generate a summary report (420, 520) as a function of the summary data generated for the plurality of patient reports (120₁ . . . 120ₙ).

12. The system (100) of claim 11, wherein the input/output device (102) includes a display configured to present the summary report to a user.

14. The system (100) of claim 10, wherein the second data is identified using NLP sentence boundary detection algorithms.

15. The system (100) of claim 10, wherein the second data is identified by determining which sentences or phrases in the at least one section contain first medical information.

16. The system (100) of claim 15 wherein the first medical information is identified using supportive phrases which indicate the presence of at least one of a medical diagnosis or interpretation.

17. The system (100) of claim 15, wherein the important information is determined by identifying the presence of medical diagnosis or interpretation.

18. The system (100) of claim 10, wherein the processor (104) is further configured to suppress specific instances of the second data that appear in more than one of the plurality of patient reports (120₁ . . . 120ₙ).

19. The system (100) of claim 10, wherein the memory arrangement (106) stores the plurality of patient reports (120₁ . . . 120ₙ).

20. The system (100) of claim 10, wherein the plurality of patient reports (120₁ . . . 120ₙ) are stored remotely from the system (100).
